(19) United States
(12) Patent Application Publication
(10) Pub. No.: US 2016/0089869 A1
(43) Pub. Date: Mar. 31, 2016

(54) PRESSURE COMPENSATED INSULATED GLASS UNITS

(71) Applicant: VIEW, INC., Milpitas, CA (US)

(72) Inventors: Ronald M. Parker, Olive Branch, MS (US); Trevor Frank, San Jose, CA (US); Ryan Taylor, Santa Rosa, CA (US)

(73) Assignee: VIEW, INC., Milpitas, CA (US)

(21) Appl. No.: 14/782,772

(22) PCT Filed: Apr. 11, 2014
(86) PCT No.: PCT/US2014/033870

§ 371 Date: Oct. 6, 2015

Related U.S. Application Data
(60) Provisional application No. 61/810,994, filed on Apr. 11, 2013.

(51) Int. Cl. B32B 37/18; E06B 3/67; E06B 3/673; E06B 3/677; B32B 37/06; B32B 37/08

(52) U.S. Cl. CPC B32B 37/18; B32B 37/06; B32B 37/08; E06B 3/67326; E06B 3/6775; E06B 3/6715; B32B 2315/08

(57) ABSTRACT

Methods and apparatus for fabricating pressure compensated insulated glass units (IGUs). In one example, a method assembles an IGU from a first lite, a second lite and a spacer registered with and between the first and second lite, while at least the space between the first and second lites and within the perimeter of the spacer contains a heated or cooled inert gas. In another example, a method provides a vented IGU, heats or cools the vented IGU, introduces inert gas into the interior volume of the vented IGU, and seals vent ports before the IGU comes to ambient temperature. In another example, a method introduces or removes inert gas from an IGU by penetrating a seal of the IGU and then reseals the IGU. In another example, an apparatus for fabricating an IGU comprises a temperature control unit configured to heat or cool an inert gas and an IGU press wherein the apparatus is configured to introduce a heated inert gas or a cooled inert gas into the IGU as the hermetic seal of the IGU is formed.

### CROSS-REFERENCE TO RELATED APPLICATIONS

This application claims priority to U.S. Provisional Application No. 61/810,994, titled “PRESSURE COMPENSATED INSULATED GLASS UNITS” and filed on Apr. 11, 2013, which is hereby incorporated by reference in its entirety and for all purposes.

### FIELD

This disclosure relates generally to insulated glass units (IGUs) and methods of fabricating IGUs, and more particularly to pressure compensated IGUs. In some cases, the pressure compensated IGUs may include one or more optically switchable devices such as electrochromic devices.

### BACKGROUND

Various optically switchable devices are available for controlling tinting, reflectivity, etc., of window panes or lites. Electrochromic devices are one example of optically switchable devices. Electrochromism is a phenomenon in which a material exhibits a reversible electrochemically-mediated change in an optical property when placed in a different electronic state, typically by being subjected to a voltage change. The optical property being manipulated is typically one or more of color, transmittance, absorbance, and reflectance. One well-known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for home, commercial, and other uses. The color, transmittance, absorbance, and/or reflectance of such windows may be changed by inducing a change in the electrochromic material; i.e., electrochromic windows are windows that can be darkened or lightened electronically. A small voltage applied to an electrochromic device of the window will cause it to darken; reversing the voltage causes it to lighten. This capability allows for control of the amount of light that passes through the window, and presents an enormous opportunity for electrochromic windows to be used not only for aesthetic purposes but also for significant energy-savings. With energy conservation being foremost in modern energy policy, it is expected that growth of the electrochromic window industry will be robust in the coming years.

### SUMMARY

Aspects of the disclosure concern pressure compensated IGUs and methods and apparatus for fabricating pressure compensated IGUs. In certain aspects, a pressure compensated IGU may include one or more optically switchable devices such as electrochromic devices.

Certain aspects of the disclosure concern methods of fabricating an IGU from a first lite, a second lite and a spacer, registered with and between the first and second lite, while at least the space between the first and second lites and within the perimeter of the spacer contains a heated inert gas or a cooled inert gas (e.g., argon, xenon, krypton or a mixture thereof). In some cases, the heated inert gas or the cooled inert gas are introduced into the space between the first and second lites during primary seal formation of the IGU. In one case, the heated inert gas or the cooled inert gas is introduced into the space by flushing the heated inert gas or the cooled inert gas through at least the IGU assembly area of an IGU. In certain cases, the entire IGU press comprising the IGU being fabricated is within an ambient of the heated or cooled gas.

In certain aspects, the disclosure concerns methods of fabricating an IGU comprising providing a vented IGU having a first lite, a second lite, and a spacer between the first and second lites, the spacer comprising one or more open vent ports, heating or cooling the vented IGU, introducing an inert gas into the interior volume of the vented IGU, and sealing the one or more open vent ports before the IGU comes to ambient temperature. In certain cases, the inert gas is substantially moisture free.

In certain aspects, the disclosure concerns methods of fabricating an IGU comprising introducing or removing inert gas from an IGU by penetrating a seal of the IGU, and resealing the IGU. In one case, the spacer of the IGU has a sealable septum through which the inert gas is removed or introduced. The sealable septum may comprise a heat sealing polymer so that resealing the IGU comprises applying heat to the area of the penetrated sealing septum.

In certain aspects, the disclosure concerns apparatus for fabricating an IGU, the apparatus comprising a temperature control unit configured to heat or cool an inert gas and an IGU press wherein the apparatus is configured to introduce a heated inert gas or a cooled inert gas into the IGU as the hermetic seal of the IGU is formed. In certain cases, the temperature control unit is an inline heater configured to heat an inert gas that passes through it. In one of these cases, the apparatus may further comprise a manifold between the IGU press and the inline heater, the manifold configured to provide heated gas from the inline heater to the IGU press and to a bypass valve for venting the heated gas when the IGU press is not fabricating IGUs. In certain cases, the IGU press is housed within a chamber such that the entire IGU press is within an ambient of the heated inert gas or the cooled inert gas. In one of these cases, the apparatus further comprises one or more thermocouples configured to measure the temperature of the heated gas delivered to the IGU press and measure the temperature of the heated gas from the gas heater.

Certain aspects of the disclosure concern methods of manufacturing IGUs where during a gas fill stage, the IGUs are filled with a heated or cooled (relative to ambient) gas, e.g. argon, xenon, krypton and mixtures thereof, and sealed in order to create (once at ambient temperature) a partially evacuated or a partially pressurized IGU. The described IGUs compensate for pressure differences between the manufacturing site and the installation site. Described embodiments go against conventional wisdom by intentionally fabricating IGUs with the altitude of the installation site in mind.

Embodiments described may avoid the use of pressure equalizing capillary or breather tubes, which inevitably allow inert gas fill to escape and/or add unwanted processing steps to IGU fabrication. The IGUs are sealed with the heated or cooled gas within the sealed volume of the IGU. The temperature of the gas is chosen so as not to result in implosion or explosion of the IGU, compromise the seal and/or apply undue stress to any coatings on the lites of the IGU. For example, IGUs having one or more electrochromic device coatings on one or both lites of the IGU are fabricated using methods described herein. The pressure compensated IGU is manufactured such that the curvature, convex or concave, of the IGU lites is not such as to damage the seal or any coatings on the lite surfaces. Moreover, in certain embodiments, the pressure or partial vacuum in the interior volume of the IGU is configured to approximate the ambient pressure at the installation site. Thus, once installed, the convex or concave form imparted to the glass by virtue of the partial pressure or vacuum inside the IGU is reduced or eliminated by virtue of the IGUs internal pressure approximating or matching that of the ambient at the installation site.

In one embodiment, e.g. using an IGU press where gas is flushed through the press during formation of the primary seal (hermetic) of the IGU, the heated or cooled gas is introduced into the IGU press during formation of the primary seal. Off-the-shelf equipment may be configured to carry out operations to meet this end.

In another embodiment, an IGU press is configured inside a chamber having an inert gas atmosphere, where the inert gas within the chamber is heated or cooled to the desired temperature during IGU primary seal formation. For example the chamber may be a conventional IGU press oven configured with inert atmosphere such that the IGU is pressed in heated inert atmosphere. In another example, the IGU formation is performed in a chamber configured with a cooled inert atmosphere. In certain embodiments, the chamber is configured to supply the inert atmosphere in a substantially moisture-free form.

In one embodiment, the inert gas is introduced into a hot IGU having one or more vent ports in the spacer. The one or more vent ports are sealed while the IGU components are still above ambient temperature. In a similar embodiment, a pre-formed IGU having one or more spacer vent ports is cooled. Inert gas is then introduced into the cooled IGU and the IGU sealed while still cool, thus trapping cooled inert gas in the IGU.

In yet another embodiment, sealed IGUs, e.g. at ambient temperature, have inert gas removed from them or introduced into them, via penetration of the seal and then resealing the seal. In one embodiment, a spacer is configured with a sealable septum. In one embodiment the sealable septum includes a heat sealing polymer and resealing the IGU includes applying heat to the area of the sealing septum penetrated during introduction or removal of inert gas. In one embodiment, a syringe pump is used to introduce or remove inert gas, e.g., via a needle that pierces the sealable septum. Heated or cooled inert gas may be introduced into the IGU, but also ambient temperature gas may be used in such embodiments. When gas is being removed from an IGU, no extra gas may be needed.

These and other features and advantages will be described in further detail below, with reference to the associated drawings.

### BRIEF DESCRIPTION OF THE DRAWINGS

FIG. 1A is an illustration of an IGU fabrication process, according to embodiments.

FIG. 1B depicts a cut away close up of and IGU's structure.

FIG. 2A is a flowchart illustrating an example of a method of fabricating a pressure compensated IGU, according to embodiments.

FIG. 2B is a flowchart illustrating a method of fabricating a pressure compensated IGU.

FIG. 2C is a flowchart illustrating a method of fabricating a pressure compensated IGU.

FIG. 3 depicts a schematic of an apparatus for manufacturing pressure compensated IGUs.

### DETAILED DESCRIPTION

It should be understood that while certain disclosed embodiments focus on IGUs with electrochromic devices, the concepts disclosed herein may apply to fabrication of other IGUs and other types of optically switchable devices, including liquid crystal devices, suspended particle devices, and the like. For example, a liquid crystal device or a suspended particle device, instead of an electrochromic device, could be incorporated into certain disclosed embodiments. For example, one or more lites of an IGU may be a laminated structure having a liquid crystal, suspended particle, or electrochromic device between laminated substrates. If the device is an all solid state device, e.g. an all solid state electrochromic device, the device coating may be on a single substrate (pane) of an IGU. Typically, such all solid state devices are protected by the protected environment afforded by the sealed volume of an IGU which typically includes an inert gas which is often dry as well.

In disclosed embodiments, an IGU includes at least two substantially transparent substrates having a spacer disposed between the substrates. For example, an IGU may include two glass sheets (lites) registered with a spacer (e.g., metal or polymeric spacer) having a smaller width and length than the glass lites and disposed between the lites. At least one lite may include an electrochromic device disposed thereon. In some cases, one of the substantially transparent substrates may be a laminate structure of lites. An IGU is typically hermetically sealed, having an interior volume that is isolated from the ambient environment. In an IGU having two substantially transparent substrates, the interior volume can be approximately defined by the interior surfaces of the two substantially transparent substrates and the interior perimeter surfaces of the spacer.

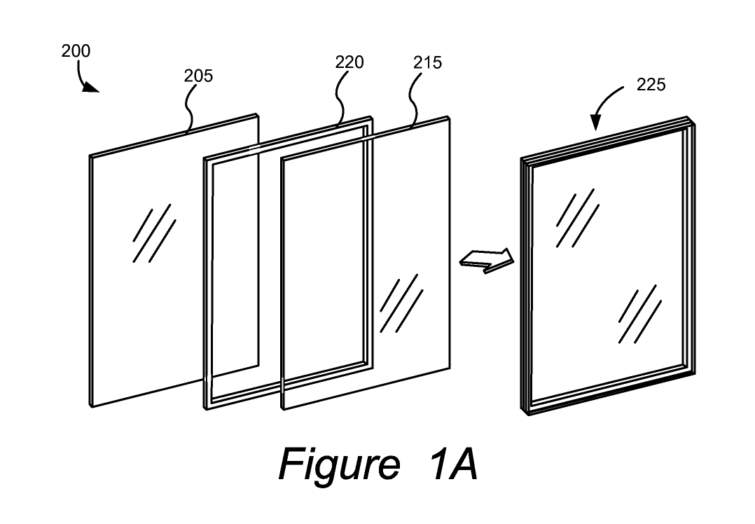

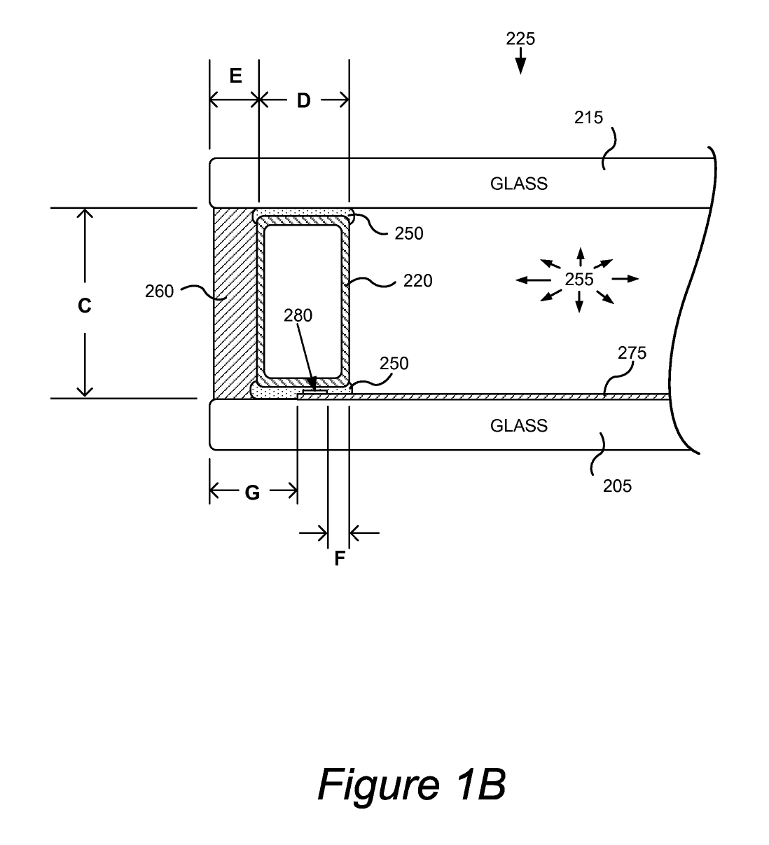

FIG. 1A is a simplified illustration of an insulated glass unit (IGU) fabrication process, 200, shown fabricating an IGU, 225. In this example, the substantially transparent substrates are a first lite, 205, and a second lite, 215, registered with a spacer, 220. Spacer 220 may be, for example, a metal or foam (polymeric) spacer that has a smaller width and length than the first and second lites, 205 and 215. Some examples of spacers that can be used in IGUs are described in U.S. patent application Ser. No. 13/312,057, filed on Dec. 6, 2011 and titled “SPACERS FOR INSULATED GLASS UNITS,” which is hereby incorporated by reference in its entirety. IGU 225 has an associated interior volume defined by the faces of lites, 205 and 215, in contact with spacer 220 and the interior perimeter surfaces of spacer 220. FIG. 1B shows a close up cut away perspective of construction aspects of IGU 225.

During the illustrated fabrication process 200 of IGU 225, spacer 220 is sandwiched in between and registered with the first and second lites, 205 and 215. A sealant material is applied so as to lie between the mating surfaces of first and second lites, 205 and 215, and spacer 220. Then, the three components are pressed together such that a hermetic seal is formed between the lite and spacer surfaces, thus forming the IGU 225. The IGU 225 is typically filled with an inert gas so as to provide insulation value, as the inert gas conducts less heat than air. The seal formed between spacer 220 and lites, 205 and 215, is called a primary seal. A secondary sealant material is typically applied around the perimeter of the spacer and between the glass sheets to form what is commonly referred to as a secondary seal. The secondary seal, although also a sealing element, also provides structural rigidity to the IGU.

FIG. 1B shows a more detailed structure of IGU 225. In this example, glass lites 205 and 215 are registered and parallel with each other. Spacer 220 mates on two of its surfaces with the lites with the aid of an adhesive, 250, e.g. polyisobutylene (PIB), to form the primary seal. A sealed volume, 255, is therefore formed. A secondary sealant, 260, is typically used as well, but not necessarily (e.g. if butt joints are to be used). In this example, an electrochromic device coating, 275, is fabricated on the inner surface of one of the lites, and includes a bus bar, 280, to provide electrical energy to coating 275 in order to effect switching of the device, e.g., from tinted to clear or the reverse. It is desirable to have an inert and dry atmosphere within interior volume 255 whether the IGU includes a device coating or not. However, it is even more important to maintain the inert and dry environment for IGUs having such device coatings within the interior volume, because many such devices are moisture sensitive and an inert atmosphere prevents any reactive gases from affecting the coating over time (e.g. oxygen).

The primary (and secondary) seal is subject to breach due to mechanical forces acting on the structure. For example, conventionally, if the IGU is made at sea level and the installation site is in the mountains, since the IGU was sealed at sea level, it contains the pressure at sea level. When it was sealed there was no pressure differential between the ambient and the interior volume. Once it is transferred to high altitudes, the sealed volume will have an effective pressure relative to the ambient. This often causes mechanical forces to deleteriously affect the primary (and secondary) seal of the IGU. Conventionally this problem was overcome by using a capillary or breather tube to equilibrate the pressure to equalize the pressure when an IGU has been moved from a first altitude to a second altitude. The problem with conventional breather tubes is that the inert gas exchanges with the ambient and is lost in a relatively short time. Even if the capillary is opened merely to equalize the pressure and then resealed, often there is gas exchange and inert gas is lost. This potentially introduces moisture (despite desiccant in the spacer) and/or, even though resealed, or provides ingress due to failure of the capillary tube to reseal. Loss of inert gas also results in loss of insulation value of the IGU. Embodiments herein provide pressure equalization based on the intended installation site, not the production facility. Also, embodiments provide for this pressure equalization without having to compromise the hermetic seal of the IGU.

One conventional type of primary seal formation for IGUs uses an ambient temperature sealant with high pressure application to form the hermetic primary seal. In other conventional methods, the primary sealant is a hot seal type sealant, e.g., the IGU may be heated in an oven press at temperatures up to 800° C. For example, IGU components may be pressed together while slowly being conveyed through an oven, heating the sealant material sufficiently to flow and form a hermetic bond between the glass lites and the spacer. Concurrently, not only the primary sealing areas but also the IGU components are heated significantly above room temperature and thus the IGUs are vented using a spacer with a vent port. During sealing, air exchange between the volume of the IGU and the external environment occurs at least as a result of the vent port. The IGUs are cooled prior to introduction of inert gas fill, but gas exchange occurs while cooling. Once cooled to ambient, the inert gas is introduced via the vent port and the port sealed. Finally the secondary sealant is applied. Thus, these conventional IGU fabrication methods are designed to specifically avoid pressure or vacuum differentials in the finished IGU.

As described above, one problem with conventional IGU fabrication methods is that if the IGU is manufactured at a particular altitude and then shipped to a higher or lower altitude, then the pressure variance, between inside the sealed IGU and the ambient, creates either a pressurized IGU or a partially evacuated IGU. The lites of a pressurized IGU or partially-evacuated IGU may bulge or depress, which can cause many problems. For example, concavity in an IGU may take a parabolic shape and thus concentrate reflected sunlight creating very hot areas on surrounding structures. Also, due to the resultant mechanical forces, bulged or depressed IGU lites can compromise the seal(s) of the IGU, allowing the inert gas to escape, thus ruining what was meant to be an insulating component of a building's skin. In extreme cases, the IGU could shatter, which may be dangerous to people near or under the IGU when it breaks.

Disclosed herein are various embodiments of methods of manufacturing IGUs that have improved techniques for compensating for pressure variances between the manufacturing site and the installation site of the IGUs. For example, described methods include a gas fill operation where IGUs are filled with a heated or cooled (relative to ambient) inert gas, e.g., argon, xenon, krypton or mixtures thereof. Once filled with heated/cooled inert gas, the IGUs are sealed in order to create (once at ambient temperature) a partially-evacuated or a partially-pressurized IGU, which is referred to herein as a pressure compensated IGU. The described IGUs may compensate for pressure differences between the manufacturing site and the installation site. Described embodiments go against conventional wisdom by intentionally fabricating IGUs with an initial pressure difference at the manufacturing site with the altitude of the installation site in mind. Certain embodiments described herein avoid the use of conventional pressure equalizing capillary or breather tubes, which can allow inert gas fill to escape and/or add unwanted processing steps to IGU fabrication.

In certain described embodiments, the IGUs are formed (the primary seal established) with a heated or cooled inert gas (trapped) within the sealed volume of the IGU and/or otherwise evacuated or pressurized with inert gas at the production facility. The pressure or vacuum within the interior volume, e.g. as a result of the temperature of the heated/cooled inert gas, is chosen so as not to result in implosion or explosion of the IGU, not to compromise the seal(s), and/or not to apply undue stress to any coatings on the lites of the IGU. For example, IGUs having one or more electrochromic device coatings on one or both lites of an IGU can be fabricated using methods described herein. In the described embodiments, the pressure compensated IGUs are manufactured such that the curvature, convex or concave, of the IGU lites is not to the extent that it may damage the seal(s) or any coatings on the surfaces of the IGU lites. The idea is to create a partial pressure or vacuum within the interior volume that approximates the ambient atmospheric pressure at the installation site, so that there is no appreciable pressure differential once installed (and thus no bulge or concavity in the glass once installed). The average temperature of the IGU at the installation site may also be factored in to approximate pressure equalization across seasonal changes, heat load on the window and heating/cooling regimes of the building where the IGU is installed.

Examples of electrochromic device coatings that can be deposited on one or more lites (electrochromic lites) of the pressure compensated IGUs are described in U.S. patent application Ser. No. 12/772,055 (issued as U.S. Pat. No. 8,300,298) filed on Apr. 30, 2010 and titled “Electrochromic Devices,” and U.S. patent application Ser. No. 12/645,159 (issued as U.S. Pat. No. 8,432,603) filed on Apr. 30, 2010 and titled “Electrochromic Devices,” where are hereby incorporated by reference in their entirety.

The electrochromic device coatings include an electrochromic stack that comprises a series of layers. In many cases, the electrochromic stack includes an electrochromic layer, an electrolyte layer, and an ion storage layer. In other cases, the electrochromic stack may include an electrochromic layer and an ion storage layer with an interfacial region that acts as an electrolyte layer. The electrochromic stack is deposited on a first transparent conducting oxide (TCO) layer on the substantially transparent substrate or over a diffusion barrier on the substantially transparent substrate. A second TCO layer is deposited over the electrochromic stack.

Methods described herein include first forming an IGU by establishing the primary (hermetic) seal, and then introducing or removing inert gas from the interior volume and/or establishing the primary seal in the presence of heated or cooled inert gas, such that the gas is trapped within the interior volume as the IGU is formed.

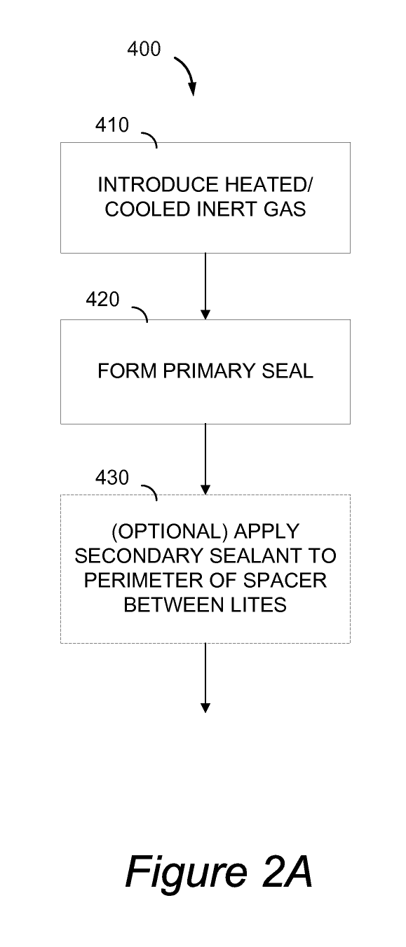

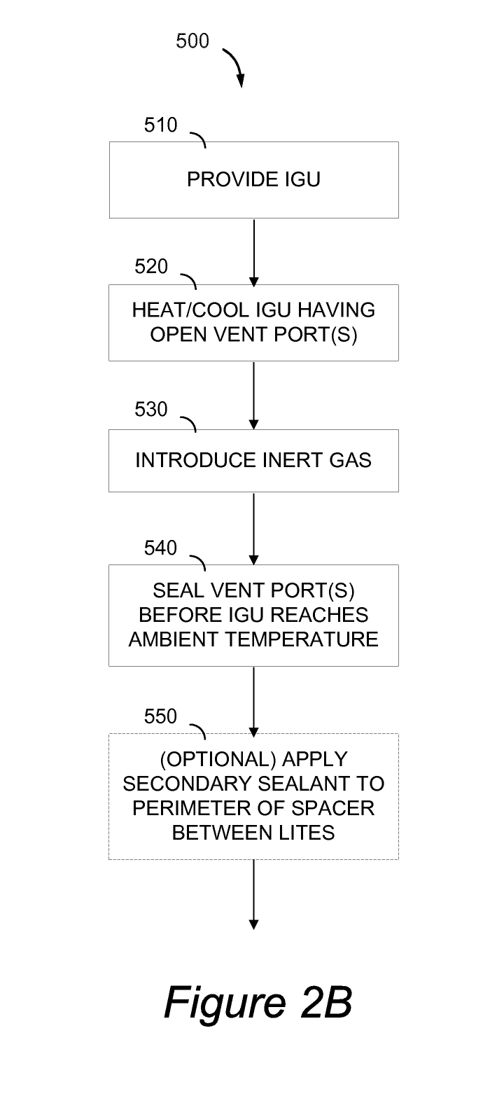

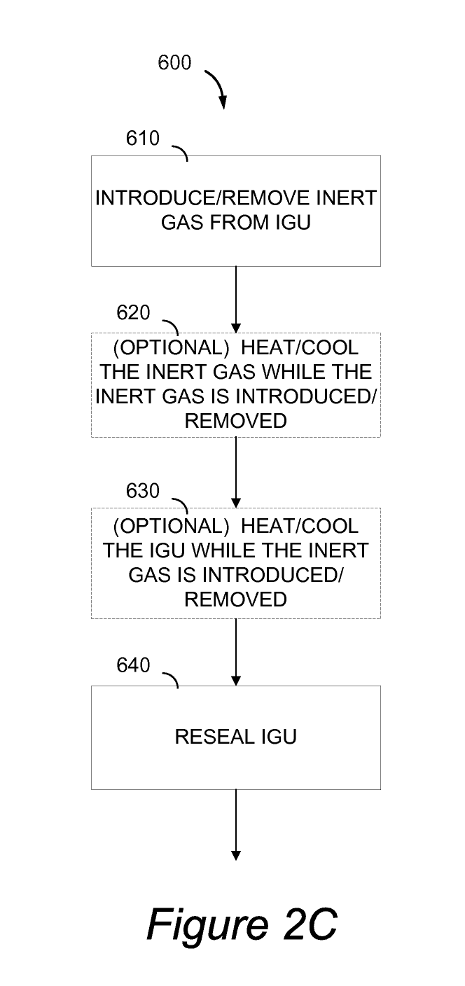

FIG. 2A is a flowchart illustrating an example of a method of fabricating a pressure compensated IGU, 400, according to embodiments. The method 400 introduces a heated or cooled inert gas into a space between a (registered) first lite and a second lite and a spacer used to form the IGU (step 410). Examples of inert gases include argon, xenon, krypton, or a mixture thereof. Argon is typically used, but xenon and krypton have higher insulative properties; and, due to the higher price of the latter two, mixtures are sometimes used.

The gas temperature sealed into the IGU may be between about −50° C. to about +150° C. In one embodiment, the inert gas has a temperature of between 30° C. and about 150° C. The method also comprises forming a primary seal and thus the IGU (step 420). Step 420 is an example of a gas fill operation where the interior volume of the IGU is established (primary seal formed) with a heated or cooled inert gas therein. No further fill operation is necessary, and such methods can use standard IGU components, e.g. spacers and sealants. Optionally, method 400 may also comprise applying a secondary sealant to a perimeter of the spacer between the first and second lites (step 430). Typically, the method 400 further comprises allowing the IGU to come to the ambient temperature at the manufacturing site after step 420 or after step 430.

In certain embodiments, the IGU fabrication methods involve using an IGU press to press together IGU components (e.g., lites, adhesive and spacer) during one or more operations. In some cases, the IGU press may be located in a chamber to provide a controlled environment or the IGU press itself may provide a controlled environment during the operation(s). For example, the IGU press may be located within an oven chamber or refrigerated chamber during one or more operations to control the temperature of the IGU, the chamber having an inert gas environment. In one example, the chamber may be a conventional IGU press oven configured with inert gas atmosphere such that the IGU is pressed in a heated inert gas atmosphere. In another example, IGU formation is performed in a chamber configured with a cooled inert gas atmosphere. In certain cases, the chamber is configured to supply the inert gas atmosphere in a substantially moisture-free form.

In another example, heated or cooled inert gas is introduced only to some areas of the IGU press, rather than the entire IGU press, prior to IGU formation. In one embodiment, an inert gas is flushed through the registered IGU components in the IGU press during formation of the primary seal to form the IGU. A specific example of one such embodiment is described in more detail in the Example section below. The inert gas may be supplied in a substantially moisture-free form.

In certain embodiments, an IGU, or its components, are heated or cooled before the inert gas is introduced into the IGU (either after the IGU is formed or during primary seal formation). In one embodiment, the inert gas is introduced into a hot IGU having one or more vent ports in the spacer. The one or more vent ports are sealed while the IGU components are still above ambient temperature. In a similar embodiment, an IGU having one or more spacer vent ports is cooled. Inert gas is then introduced into the cooled IGU and the IGU sealed while still cool, thus trapping cooled inert gas in the IGU.

FIG. 2B is a flowchart illustrating an example of a method of fabricating a pressure compensated IGU, 500, according to embodiments. In this method 500, the IGU is heated or cooled before the inert gas is introduced into the IGU. As shown, method 500 includes providing an IGU having a first lite, a second lite, and a spacer between the first and second lites (step 510). Method 500 also includes heating or cooling the IGU having one or more open vent ports in the spacer (step 520). Method 500 includes introducing an inert gas into the interior volume of the IGU (step 530). The inert gas may be argon, xenon, krypton, or a mixture thereof. The inert gas may also be heated or cooled. The inert gas may be substantially moisture free. Once the inert gas is introduced, the one or more open vent ports are sealed before the IGU comes to ambient temperature (step 540). Optionally, method 500 may also include applying a secondary sealant to a perimeter of the spacer between the first and second lites (step 550).

In yet other embodiments, sealed IGUs, e.g. at ambient temperature or not, have inert gas removed from them, or introduced into them (at ambient temperature or not), via penetration of a seal and then resealing the seal. That is, these embodiments may include addition or removal of inert gas at ambient temperature of the IGU and the gas, or, the IGU and/or the gas may be at other than ambient temperature (e.g. between about −50° C. and about +150° C.). In this way, for example, the volume exchanged during the introduction or removal of inert gas may be lessened relative to not using heated or cooled gas and/or IGU. For example, it may be required to add inert gas of a particular temperature (based on the entire volume of the interior space) to obtain a final pressure level within the IGU. Rather than exchanging the entire volume with gas at that particular temperature, a smaller volume of hotter gas may be introduced to achieve the same end.

The seal may be part of, or otherwise integrated with, the spacer. For example, the spacer may be configured with a seal in the form of a sealable septum. In one embodiment, the sealable septum is self-sealing, e.g. made of a polymeric material that allows penetration of a needle to transfer gas in or out of the interior volume, but which seals upon removal of the needle. In one embodiment, the sealable septum includes a heat sealing polymer and resealing the IGU includes applying heat to the area of the sealing septum penetrated during introduction or removal of inert gas. The instrument, e.g. a needle, used to transfer the gas may be heated or heatable, so that it locally melts the seal's material during penetration thereof, and thus allows the seal material to flow locally and reseal upon removal of the needle. In certain embodiments, a syringe pump is used to introduce or remove inert gas, e.g., via a needle that pierces the sealable septum or other seal. Use of a syringe pump allows for precise volumes to be introduced or removed from the IGU (in embodiments where heated or cooled gas is introduced while making the primary seal, e.g. in an IGU press, the (entire) interior volume of the IGU is established simultaneously with introduction of the heated or cooled gas).

FIG. 2C is a flowchart illustrating an example of a method of fabricating a pressure compensated IGU, 600, according to embodiments. In this method 600, an inert gas (e.g., argon, xenon, krypton, or a mixture thereof) is removed from, or introduced into, the interior space in the IGU via penetration of a seal. The inert gas may be substantially moisture free. At step 610, method 600 includes introducing an inert gas into or removing inert gas from the interior space in an IGU by penetrating a seal of the IGU. In some cases, a syringe pump can be used to penetrate the seal of the IGU and remove/introduce inert gas from/to the IGU. Optionally, the inert gas may also be heated or cooled, see 620. Optionally, the IGU may also be heated or cooled, see 630, during transfer of the inert gas into or out of the interior volume. In some cases, the optional steps 620 and 630 may both occur. At step 640, the method 600 reseals the IGU. In some cases, the spacer of the IGU has a sealable septum through which the inert gas is removed or introduced. In one case, the sealable septum comprises a heat sealing polymer. In this case, resealing the IGU can include heating the area of the sealing septum around which was penetrated during introduction or removal of the inert gas. In one embodiment, method 600 may include repeating steps 610-640, e.g. if pre-formed pressure compensated IGUs are used to create pressure compensated IGUs having a different pressure within the interior volume. For example, a particular customer reports the elevation of his installation site incorrectly to the manufacturer. The pressure compensated IGUs are fabricated for this elevation. The correct elevation is revealed. The pressure compensated IGUs are recalibrated to the correct interior volume pressure. Re-sealable IGUs have the advantage of allowing such operations.

The methods of fabricating pressure compensated IGUs can include one or more operations of the IGU fabrication processes described in reference to FIGS. 1A-1B. For example, the methods described with reference to FIGS. 2A-2C can include one or more operations of forming IGUs as described with reference to FIGS. 1A-1B.

### Example I

### Temperatures of Inert Gas Sealed in IGU During Fabrication of Pressure Compensated IGUs

Based on Ideal Gas Law, one can calculate the desired fill temperature of the inert gas that needs to be sealed into an IGU in order to compensate for the pressure variance at various altitudes and room temperature at the installation site. These particular calculations do not take into account the IGU itself being heated or cooled, that is, assuming room temperature of the IGU components (often the primary sealant and area is heated during IGU formation in a standard IGU press). That is, if the IGU is sealed with inert gas at the fill temperature associated with the given altitude of the installation site, the IGU internal pressure will be equalized to the external pressure when the IGU is at room temperature.

Table 1 is an example of a chart indicating the desired fill temperatures of inert gas (e.g., argon) needed to be sealed in an IGU in order to create a pressure compensated IGU for particular altitudes at the installation site, according to embodiments. The IGUs may be fabricated by methods herein where the IGU is sealed with inert gas of the particular temperature therein. These calculations are for Argon, but similar calculations for other inert gases and mixtures of inert gases can be determined by ordinary artisans. By fabricating pressure compensated IGUs as described herein, bowing of the glass lite, e.g. convex or concave, of the installed IGU can be substantially avoided—and inert gas (leakage) loss can also substantially avoided while obviating the need for capillary or breather tubes for pressure equalization. These temperatures listed in Table 1 assume that the IGU fabrication takes place at approximately 500 feet above sea level, thus only ambient or heated gas is described, not cooled gas. Ordinary artisans could also calculate similar temperature values for cooled gases, used to make positive pressure IGUs at high elevation for installation at lower elevation.

TABLE 1

| Altitude Above | | Absolute | | |
|---|---|---|---|---|
| Sea Level | | Atmospheric Pressure | | Argon Fill Temp |
| feet | meters | psi | kPa | ° C. |
| 500 | 152 | 14.4 | 99.5 | 25 |
| 1000 | 305 | 14.2 | 97.7 | 29 |
| 1500 | 457 | 13.9 | 96 | 36 |
| 2000 | 610 | 13.7 | 94.2 | 40 |
| 2500 | 762 | 13.4 | 92.5 | 47 |
| 3000 | 914 | 13.2 | 90.8 | 52 |
| 3500 | 1067 | 12.9 | 89.1 | 60 |
| 4000 | 1219 | 12.7 | 87.5 | 65 |
| 4500 | 1372 | 12.5 | 85.9 | 70 |
| 5000 | 1524 | 12.2 | 84.3 | 79 |
| 6000 | 1829 | 11.8 | 81.2 | 91 |
| 7000 | 2134 | 11.3 | 78.2 | 107 |
| 8000 | 2438 | 10.9 | 75.3 | 121 |
| 9000 | 2743 | 10.5 | 72.4 | 136 |
| 10000 | 3048 | 10.1 | 69.7 | 152 |

### Example II

### Fabrication of Pressure Compensated IGUs

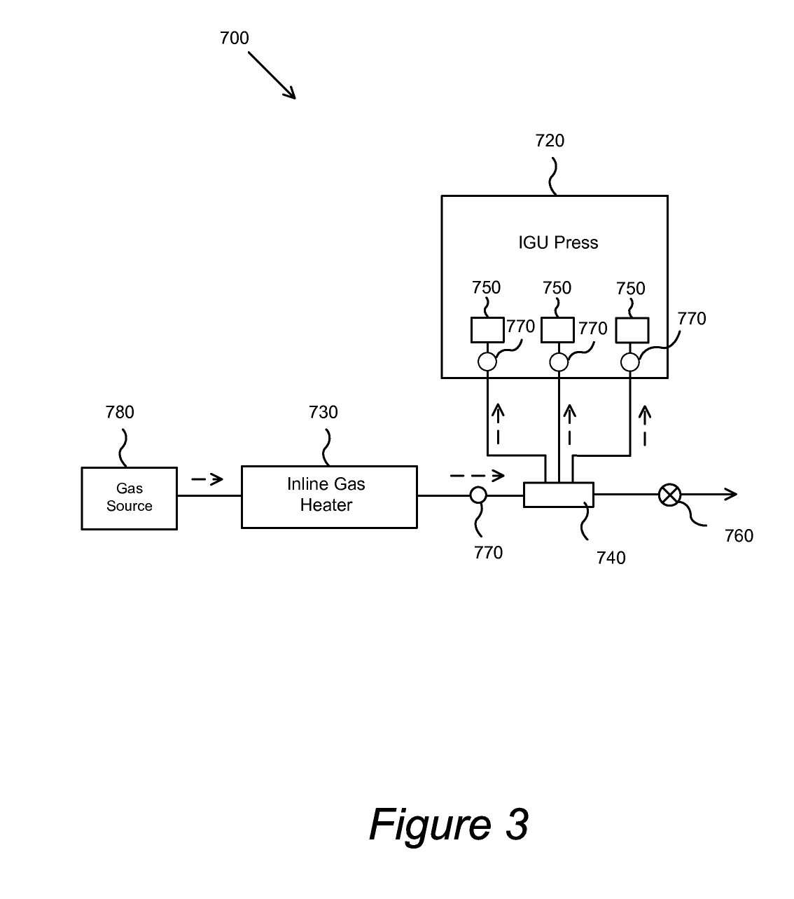

FIG. 3 depicts a schematic drawing of exemplary apparatus for fabricating pressure compensated IGUs, 700. In this illustration, the apparatus 700 includes an IGU press, 720, fitted with an inline gas heater, 730 (e.g., the commercially available heater from Imtec Acculine, LLC. of Fremont, Calif.) that delivers heated gas (e.g., argon) into a four-way gas delivery manifold, 740. The IGU press 720 includes three gas filling ports, 750. Depending upon the size of the IGU, between one and three of gas filling ports 750 are used for gas fill of IGUs during operation. A four-way gas manifold 740 is fitted to the system apparatus 700, whereby three of the manifold ports are plumbed to deliver gas to the three gas filling ports 750 of IGU press 720. The final (fourth) manifold port of four-way manifold 740 is used for a bypass valve, 760, (e.g. fitted with a solenoid activated valve) to release pressure if necessary or allow gas to flow out of the system while coming up to the desired temperature. Inline gas heater 730 feeds into the four-way manifold 740. The gas lines to and from the four-way manifold 740 are fitted with thermocouples, 770, for measuring the gas temperature within the gas lines, e.g., just after the inline gas heater 730, just after exiting the four-way manifold 740 and just before the filling ports 750 of IGU press 720 (the heater also has internal thermocouples). Inline gas heater 730 receives gas from the gas source 780.

During operation, when inline gas heater 730 is on and IGUs are not being filled, bypass valve 760 is open and the heated gas is allowed to pass through the four-way manifold 740, not to the IGU press filling ports 750, and out the open bypass valve 760. During a filling operation, bypass valve 760 is closed, and the heated gas flows to one or more filling ports 750 of the IGU press 720 (gas filling ports have internal valves as well, so that one, two or three can be used). Apparatus 700 is configured to deliver gas at temperatures between about 25° C. and about 260° C. In a typical gas fill operation, gas used to make IGUs is at a temperature between about 90° C. and about 150° C. A number of 14″ by 14″ IGUs were successfully fabricated using heated argon using apparatus 700 as illustrated in FIG. 3. IGUs were fabricated using 90° C., 120° C. and 150° C. argon and submitted for durability testing.

Although the foregoing embodiments have been described in some detail to facilitate understanding, the described embodiments are to be considered illustrative and not limiting. It will be apparent to one of ordinary skill in the art that certain changes and modifications can be practiced within the scope of the appended claims. For example, although an inline heater has been described with reference to FIG. 3, another temperature control unit can be used such as a refrigeration unit for cooling the inert gas.

What is claimed is:

1. A method of fabricating an insulated glass unit (IGU), the method comprising assembling the IGU from a first lite, a second lite and a spacer, registered with and between the first and second lite, while at least the space between the first and second lites and within the perimeter of the spacer contains a heated inert gas or a cooled inert gas.

2. The method of claim 1, wherein the heated inert gas or the cooled inert gas are introduced into the space between the first and second lites during primary seal formation of the IGU.

3. The method of claim 1, wherein the heated or cooled inert gas is argon, xenon, krypton or a mixture thereof.

4. The method of claim 1, further comprising applying a secondary sealant to the outer perimeter of the spacer and between the first and second lites.

5. The method of claim 1, wherein the heated inert gas has a temperature of between about 30° C. and about 150° C.

6. The method of claim 2, wherein the heated inert gas or the cooled inert gas is introduced into the space by flushing the heated inert gas or the cooled inert gas through at least an IGU assembly area of the IGU.

7. The method of claim 1, wherein an entire IGU press is within an ambient of the heated or the cooled inert gas.

8. A method of fabricating a pressure compensated IGU, the method comprising:
a) providing a vented IGU having a first lite, a second lite, and a spacer between the first and second lites, the spacer comprising one or more open vent ports;
b) heating or cooling the vented IGU;
c) introducing an inert gas into the interior volume of the vented IGU; and
d) sealing the one or more open vent ports before the IGU comes to ambient temperature.

9. The method of claim 8, wherein the inert gas is argon, xenon, krypton or a mixture thereof.

10. The method of claim 8 or 9, wherein the inert gas is substantially moisture free.

11. The method of claim 8, further comprising applying a secondary sealant to the perimeter of the IGU.

12. A method of fabricating a pressure compensated IGU, the method comprising:
a) introducing or removing inert gas from an IGU by penetrating a seal of the IGU; and
b) resealing the IGU.

13. The method of claim 12, wherein the inert gas is argon, xenon, krypton or a mixture thereof.

14. The method of claim 12, wherein the spacer of the IGU has a sealable septum through which the inert gas is removed or introduced.

15. The method of claim 14, wherein the sealable septum comprises a heat sealing polymer and b) comprises applying heat to the area of the sealing septum penetrated during a).

16. The method of claim 12, wherein a syringe pump is used during a).

17. An apparatus for fabricating an IGU, comprising:
a temperature control unit configured to heat or cool an inert gas; and
an IGU press;
wherein the apparatus is configured to introduce a heated inert gas or a cooled inert gas into the IGU as the hermetic seal of the IGU is formed.

18. The apparatus of claim 17, wherein the temperature control unit is an inline heater configured to heat an inert gas that passes through it.

19. The apparatus of claim 18, further comprising a manifold between the IGU press and the inline heater, the manifold configured to provide heated gas from the inline heater to the IGU press and to a bypass valve for venting the heated gas when the IGU press is not fabricating IGUs.

20. The apparatus of claim 17, wherein the IGU press is housed within a chamber such that the entire IGU press is within an ambient of the heated inert gas or the cooled inert gas.

21. The apparatus of claim 20, further comprising one or more thermocouples configured to measure the temperature of the heated gas delivered to the IGU press and measure the temperature of the heated gas from the gas heater.

22. The apparatus of any one of claims 17-21, wherein the inert gas is argon, xenon, krypton or mixtures thereof.
